(19) United States
(12) Patent Application Publication
(10) Pub. No.: US 2009/0002860 A1
(43) Pub. Date: Jan. 1, 2009

(54) STORAGE APPARATUS AND CONTROL APPARATUS THEREOF, AND HEAD VIBRATION MEASUREMENT METHOD

(75) Inventors: Kohei Takamatsu, Kawasaki (JP); Yoshiyuki Kagami, Yokohama (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/052,520

(22) Filed: Mar. 20, 2008

(30) Foreign Application Priority Data
Jun. 28, 2007 (JP) 2007-170279

(51) Int. Cl. G11B 27/36

(52) U.S. Cl. 360/31

(57) ABSTRACT

A storage apparatus capable of measuring the vibration of a head vibration having a high frequency includes: a gate generation section that generates a plurality of first gate signals indicating the timing at which the head reads out servo information having a waveform for measurement of a reproduction signal level from a storage medium on which the servo information is written at predetermined intervals and on a first track of which a first waveform serving as a waveform for measurement of a reproduction signal level is written and which is at least a predetermined track and a second gate signal indicating at least one timing between the first gate signals; and a measurement section that measures the reproduction signal level of the waveform for measurement reproduced by the head at the timing of the gate signals.

### BACKGROUND OF THE INVENTION

1. Field of the Invention

The present invention relates to a storage apparatus that measures the vibration of a head in the storage apparatus, a control apparatus for the storage apparatus, and a head vibration measurement method.

2. Description of the Related Art

Higher TPI (Track Per Inch) recording is required in order to increase the recording density in a magnetic disk apparatus. To this end, it is necessary to control the head position more accurately. The smaller the distance between tracks on a recording medium, the more likely a head offsets from the proper writing position with a slight vibration to erase data on adjacent tracks or, in an extreme case, to write data on adjacent tracks.

As a countermeasure against the vibration, there is available a method in which a Notch Filter is applied to a VCM (Voice Coil motor) drive current so as to suppress a specific frequency component in which vibration is likely to occur, thereby reducing the vibration.

In a sector servo system, servo information for determining the head position is discretely written by a STW (Servo Track Writer). The head position control is performed by a head reading out the servo information.

As a prior art relating to the present invention, there is known a disk apparatus capable of preventing data from being written onto adjacent tracks when an impact is applied or vibration occurs (refer to, e.g., Patent Document 1: Jpn. Pat. Appln. Laid-Open Publication No. 2003-338146).

In the case of vibration in the horizontal (in-plane) direction with respect to the surface of a recording medium, it is necessary to prohibit writing operation on the recording medium before data on adjacent tracks are erased due to occurrence of vibration. Although Track Following of a head is achieved by the servo information read according to servo gates, vibration whose frequency is higher than Nyquist frequency which is ½ of the sampling frequency of the servo information or vibration whose frequency is near the Nyquist frequency cannot be measured accurately due to the sampling theorem.

In the case of vibration in the vertical (up-down) direction with respect to a recording medium, as the distance between a head and recording medium becomes large, a magnetic field generated in a write head (write gap) by a write current becomes insufficient in the strength for satisfactory writing operation, which makes the peak of a written wavelength less noticeable. In the worst case, writing operation cannot be performed satisfactorily, with the result that data that has already been written on a target track remains intact. The frequency in the vertical vibration generally exceeds 100 kHz, which is higher than the sampling frequency (40 to 50 kHz) of the servo. Thus, it is difficult to measure the vertical vibration.

### SUMMARY OF THE INVENTION

The present invention has been made to solve the above problems, and an object thereof is to provide a storage apparatus capable of measuring head vibration having a high frequency, its control apparatus, and a head vibration measurement method.

To solve the above problems, according to one aspect of the present invention, there is provided a storage apparatus capable of measuring the vibration of a head, including: a gate generation section that generates a plurality of first gate signals and a second gate signal as gate signals for measurement, the first gate signals indicating the timing at which the head reads out servo information having a waveform for measurement of a reproduction signal level from a storage medium on which the servo information is written at predetermined intervals and on a first track of which a first waveform serving as a waveform for measurement of a reproduction signal level is written and which is at least a predetermined track, and the second gate signal indicating at least one timing between the first gate signals; and a measurement section that measures the reproduction signal level of the waveform for measurement reproduced by the head at the timing of the gate signals for measurement.

According to a second aspect of the present invention, there is provided a head vibration measurement method that measures the vibration of a head in a storage apparatus, including: a first waveform writing step that writes a first waveform serving as a waveform for measurement of a reproduction signal level on a first track which is at least a predetermined track, of a storage medium on which servo information having a waveform for measurement of a reproduction signal level is written at predetermined intervals; and a measurement step that generates, as gate signals for measurement, a plurality of first gate signals indicating the timing at which the head reads out the servo information from the storage medium and a second gate signal indicating at least one timing between the first gate signals and measures the reproduction signal level of the waveform for measurement reproduced by the head at the timing of the gate signals for measurement.

According to a third aspect of the present invention, there is provided a control apparatus for a storage apparatus capable of measuring the vibration of a head, comprising: a gate generation control section that performs control operation for generating a plurality of first gate signals and a second gate signal as gate signals for measurement, the first gate signals indicating the timing at which the head reads out servo information having a waveform for measurement of a reproduction signal level from a storage medium on which the servo information is written at predetermined intervals and on a first track of which a first waveform serving as a waveform for measurement of a reproduction signal level is written and which is at least a predetermined track, and the second gate signal indicating at least one timing between the first gate signals; and a measurement control section that performs control operation for measuring the reproduction signal level of the waveform for measurement reproduced by the head at the timing of the gate signals for measurement.

According to the present invention, it is possible to measure head vibration having a high frequency.

### BRIEF DESCRIPTION OF THE DRAWINGS

FIG. 1 is a block diagram showing an example of a configuration of a magnetic disk drive according to an embodiment of the present invention;

FIG. 2 is a time chart showing an example of normal servo gates and servo information;

FIG. 3 is a flowchart showing an example of operation of a head vibration measurement method according to the present embodiment;

FIG. 4 is a time chart showing an example of gates for measurement according to the present embodiment;

FIG. 5 is a time chart showing an example of ServoGain value sampling performed using the gates for measurement according to the present embodiment;

FIG. 6 is a plan view showing an example of a pattern written on a recording medium through write processing for vertical component measurement according to the present embodiment;

FIG. 7 is a plan view showing an example of a pattern written on a recording medium through first write processing for horizontal component measurement according to the present embodiment;

FIG. 8 is a plan view showing an example of a pattern written on a recording medium through second write processing for horizontal component measurement according to the present embodiment;

FIG. 9 is a plan view showing an example of an area for measurement on a recording medium according to the present embodiment; and

FIG. 10 is a plan view showing an example of Position part written by an area servo method.

### DETAILED DESCRIPTION OF THE PREFERRED EMBODIMENTS

An embodiment of the present invention will be described below with reference to the accompanying drawings.

In an embodiment of the present invention, a magnetic disk drive to which a storage apparatus of the present invention is applied will be described.

First, a configuration of the magnetic disk drive according to the present embodiment will be described.

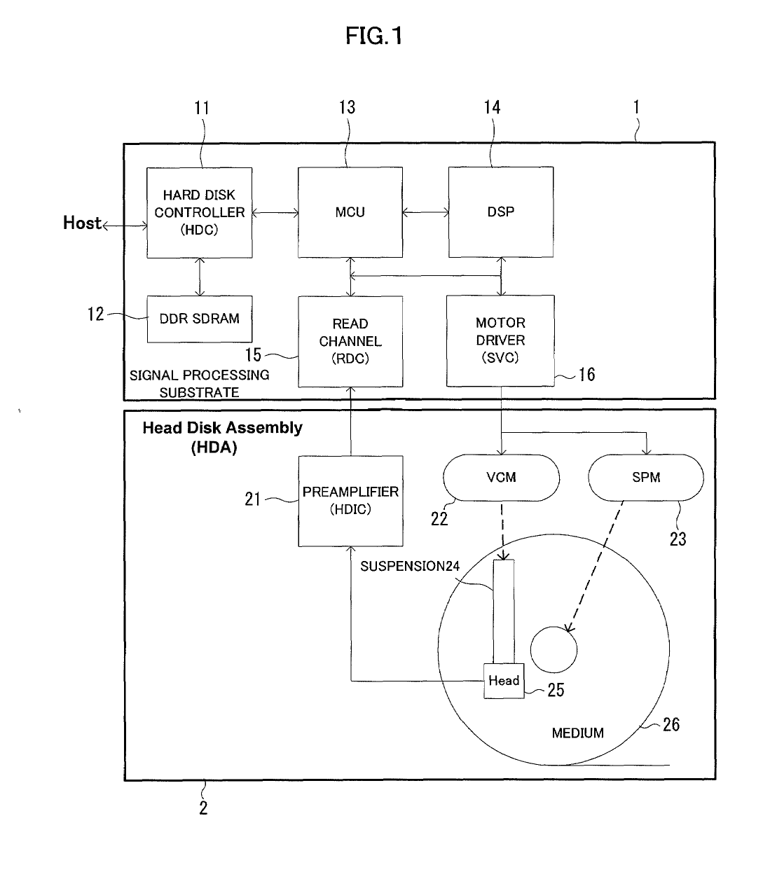

FIG. 1 is a block diagram showing an example of a configuration of the magnetic disk drive according to the present embodiment. The magnetic disk drive of FIG. 1 includes a signal processing substrate 1 and an HDA (Head Disk Assembly) 2.

The signal processing substrate 1 includes an HDC (hard disk controller) 11, a DDR (Double Data Rate), an SDRAM (Synchronous Dynamic Random Access Memory) 12, an MCU (Micro Control Unit) 13, a DSP (Digital Signal Processor) 14, an RDC (read channel) 15, and an SVC, (motor driver) 16. The HDA 2 includes an HDIC (Head IC: preamplifier) 21, a VCM 22, an SPM (Spindle Motor) 23, a suspension 24, a head 25, and a medium (recording medium) 26.

The HDC 11 communicates with a Host, receives a command from the Host, and issues an instruction to the MCU 13. The MCU 13 and DSP 14 controls the RDC 15 and SVC 16 according to an instruction from the HDC 11. The RDC 15 controls the HDIC 21 according to an instruction from the MCU 13 and DSP 14. The SVC 16 controls the VCM 22 and SPM 23 according to an instruction from the MCU 13 and DSP 14. The MCU (which may be a CPU or MPU) is a controller that controls the respective circuits according to various programs. The controller may be constituted by including the control circuits such as the MCU, DSP, and HDC.

The HDIC (preamplifier IC) 21 transfers a recording signal to the head 25 or amplifiers a reproduction signal from the head 25 according to an instruction from the RDC 15. The VCM 22 moves the suspension 24 and head 25 according to an instruction from the SVC 16. The SPM 23 rotates the medium 26 according to an instruction from the SVC 16. The suspension 24 supports the head 25. The head 25 writes a signal from the HDIC 21 onto the medium 26 and outputs a signal read out from the medium 26 to the HDIC 21. The medium 26 is a magnetic disk of an in-plane recording type or vertical recording type.

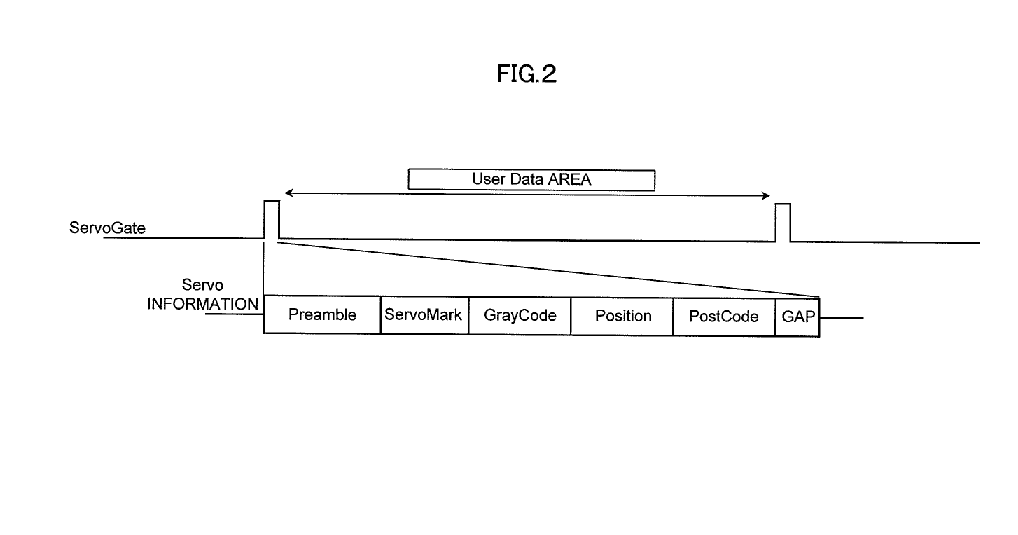

FIG. 2 is a time chart showing an example of normal servo gates and servo information. In FIG. 2, the upper stage shows normal servo gates, and lower stage shows a format of servo information read by the head 25 at the time of generation of the servo gates. The servo information has a Preamble part, ServoMark part, GrayCode part, Position part, PostCode part, and GAP part.

The RDC 15 has an AGC (Auto Gain Control) function of dynamically determining the gain of a reproduction signal in accordance with the strength of the reproduction signal in order to accurately read out the servo information. The gain (ServoGain value) is adjusted by a reproduction signal of the Preamble part (waveform for measurement) in the servo information. The gain changes depending on the distance between the head and medium, presence/absence of the Preamble part (e.g., whether erased or not or “ServoMarkLocked” or not) or the frequency of a reproduction signal output from the HDIC. For example, when the distance between the head and medium is larger than a normal value, the magnitude of a reproduction signal becomes small. In this case, the AGC increases the ServoGain value so as to increase the magnitude of the reproduction signal. Further, when the frequency of the reproduction signal becomes higher, a magnetized area of the medium is reduced to make the amplitude of the reproduction signal small. Thus, also in this case, the AGC increases the ServoGain value.

A head vibration measurement method according to the present embodiment will next be described.

In the present embodiment, the head vibration to be measured is divided into a vertical component and horizontal component with respect to the medium surface.

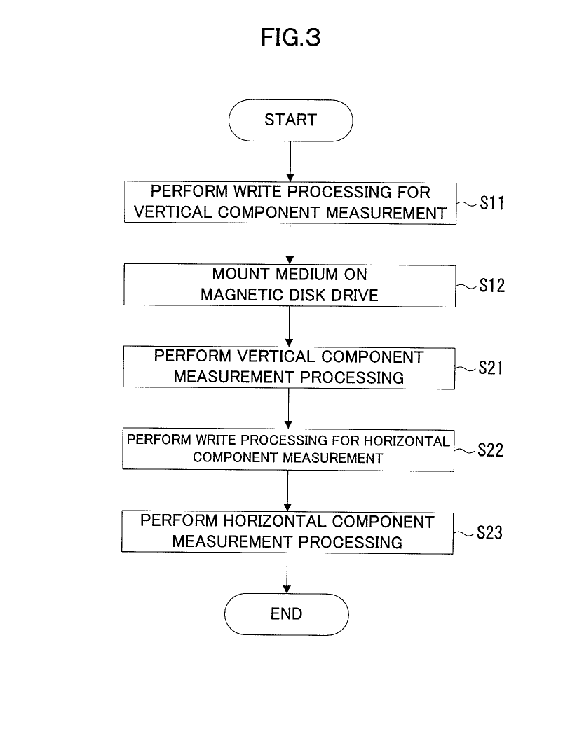

FIG. 3 is a flowchart showing an example of operation of the head vibration measurement method according to the present embodiment. The STW performs write processing for vertical component measurement that writes a pattern for vertical component measurement onto a plurality of cylinders in the vicinity of a predetermined track for vertical component measurement (S11). Subsequently, the medium 26 is mounted on the magnetic disk drive (S12).

Then, the MCU 13 of the magnetic disk drive performs vertical component measurement processing (S21) that measures the vertical component of the head vibration. The MCU 13 then performs write processing for horizontal component measurement that writes a pattern for horizontal component measurement onto a predetermined track for horizontal component measurement (S22). Then, the MCU 13 performs horizontal component measurement processing (S23) that measures the vertical component of the head vibration, and this flow is ended.

In the case where there is no need to measure the vertical component of the head vibration, only the write processing for horizontal component measurement and horizontal component measurement processing are performed.

In the vertical and horizontal component measurement processing, the RDC 15 performs the following operation using the abovementioned AGC function.

The MCU 13 generates pseudo servo gates (second gate signals) between normal servo gates (first gate signals) and uses reproduction signals at the normal servo gates and pseudo servo gates to acquire ServoGain values by means of the AGC function. Then, the RDC 15 measures the head vibration based on a variation of the ServoGain value. This operation allows measurement of vibration having a frequency higher than ½ of the frequency of the servo gate. Further, in the vertical and horizontal component measurement processing, the reproduction gain value of the HDIC 21 may be increased more than the normal use time in order to prevent the ServoGain value from being saturated due to a small amplitude of the reproduction signal.

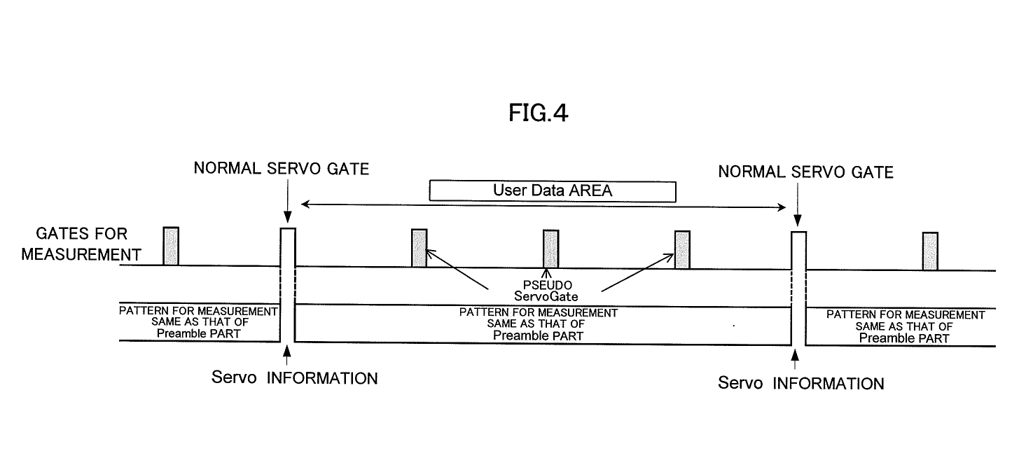

Here, the normal servo gates and pseudo servo gates are set as gates for measurement. FIG. 4 is a time chart showing an example of the gates for measurement and patterns for measurement according to the present embodiment. In FIG. 4, the upper stage shows the gates for measurement, and lower stage shows the patterns for measurement read by the head at the timing of each of the gates for measurement. In this example, three pseudo servo gates are generated at even intervals between the servo gates to set the cycle of the gates for measurement to ¼ of the cycle of the servo gate. The ServoGain is measured at this cycle of the gates for measurement. Therefore, the head vibration having a frequency up to (sampling frequency of servo gate)×(½)×4 can be measured.

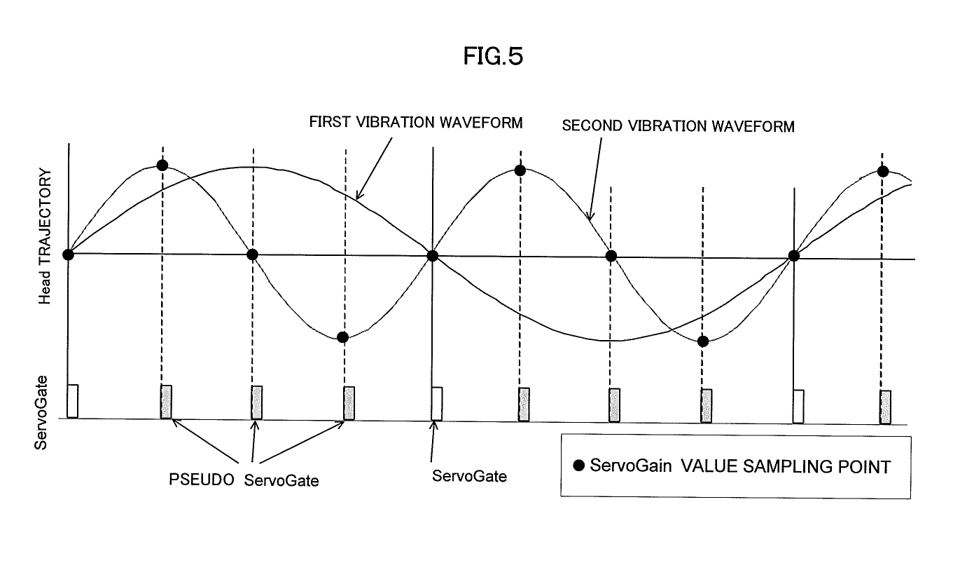

FIG. 5 is a time chart showing an example of ServoGain value sampling performed using the gates for measurement according to the present embodiment. The illustration shows a first vibration waveform which is a sine-wave having a frequency ½ of the sampling frequency of the normal servo gates and a second vibration waveform which is a sine-wave having a frequency equal to the sampling frequency of the normal servo gates. Black dots on the first and second vibration waveforms each denote a sampling point of the ServoGain value. Since the sampling was performed using only the normal servo gates in a conventional approach, the frequency of the first vibration waveform was upper limit and thus it was impossible to measure the second vibration waveform. By using the gates for measurement according to the present embodiment, the second vibration waveform can be measured.

The MCU 13 executes the measurement while controlling the respective circuit by means of a firmware program. In order to measure the ServoGain value in synchronization with the gates for measurement, the firmware needs to allow the MCU 13 to generate an interrupts synchronized with one gate for measurement and to complete the interrupt processing before synchronization with the next gate for measurement. While the firmware demodulates position information and calculates the head position based on the position information value in an interrupt generated in synchronization with the normal servo gates, the firmware skips the above processing and acquires only the ServoGain value in an interrupt generated in synchronization with each pseudo servo gate.

The write processing for vertical component measurement will next be described.

A track for vertical component measurement is previously specified. The STW performs AC Erase for a plurality (±1 cylinder or more) of cylinders in the vicinity of the track (cylinder) for vertical component measurement in units of, e.g., (⅓) track. The AC Erase is processing that writes an AC pattern (first waveform) which is a waveform of a constant frequency between the servo information. The AC pattern has the same waveform (frequency) of that of the Preamble part.

By performing the AC Erase in units of (⅓) track, it is possible to fill also the area between tracks with the AC pattern. Further, by performing the AC Erase over a plurality of cylinders, it is possible to prevent the measurement of the vertical component from being adversely affected by the horizontal component.

There are the following two reasons why the STW performs the AC Erase.

1. In the case where the AC Erase is performed in the magnetic disk drive, if vibration of the head occurs at the AC Erase time, a head signal may appear in the AC pattern, making it difficult to measure the head vibration at the measurement time.

2. In the case where the AC Erase is performed by the STW, it is possible to align the phases of the AC patterns written in units of (⅓) track.

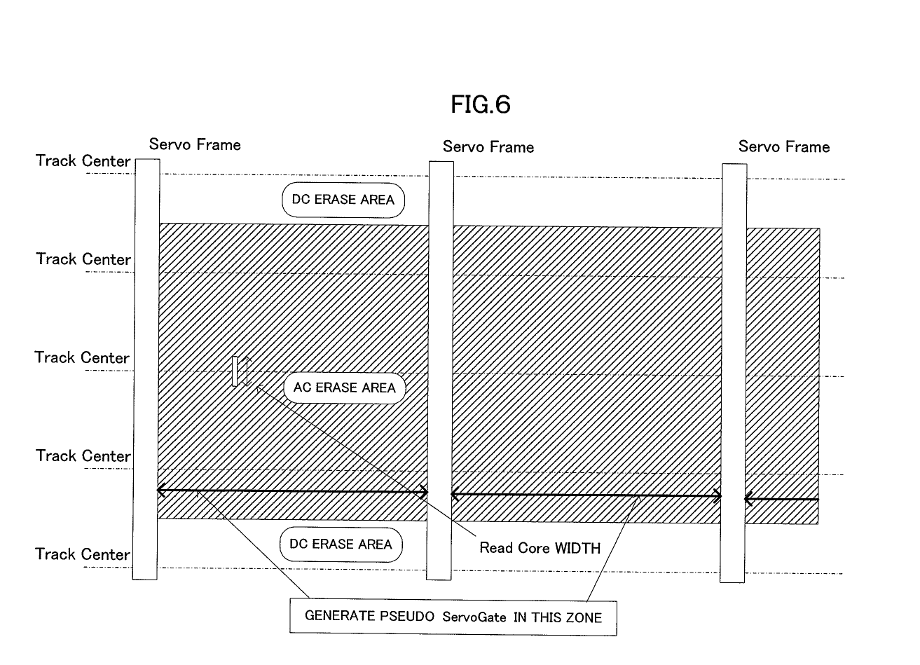

FIG. 6 is a plan view showing an example of a pattern written on the medium through the write processing for vertical component measurement according to the present embodiment. In FIG. 6, the vertical direction is the medium radial direction, and horizontal direction is the medium circumferential direction. Further, in FIG. 6, a shaded area across three cylinders (tracks) in the user data area other than the servo information (Servo Frame) is AC Erase Area, and the center track of the AC Erase Area is the track for vertical component measurement. The user data area other than the AC Erase Area is DC Erase Area. The DC Erase is processing that fills the area between servo information with a DC pattern which is a waveform having a frequency of 0 (having no amplitude variation).

The vertical component measurement processing will next be described.

The MCU 13 positions a read core on the track for vertical component measurement to check a variation of the ServoGain value which is output for each gate for measurement from the RDC 15, thereby measuring the head variation. As shown in FIG. 6, the MCU 13 generates the normal servo gate when the head passes above the servo information and generates the pseudo servo gate when the head passes above the user data area. Since the AC Erase Area exists across a plurality of tracks and phases thereof are made aligned with one another in the medium radial direction, the horizontal component of the head vibration does not appear in the variation of the ServoGain value.

The write processing for horizontal component measurement and horizontal component measurement processing will next be described using two examples, respectively.

First write processing for horizontal component measurement will be described.

A track for horizontal component measurement is previously specified. The magnetic disk drive performs AC Erase for the track for horizontal component measurement. An AC pattern (second waveform) written by the AC Erase has the same waveform (frequency) of that of the Preamble part.

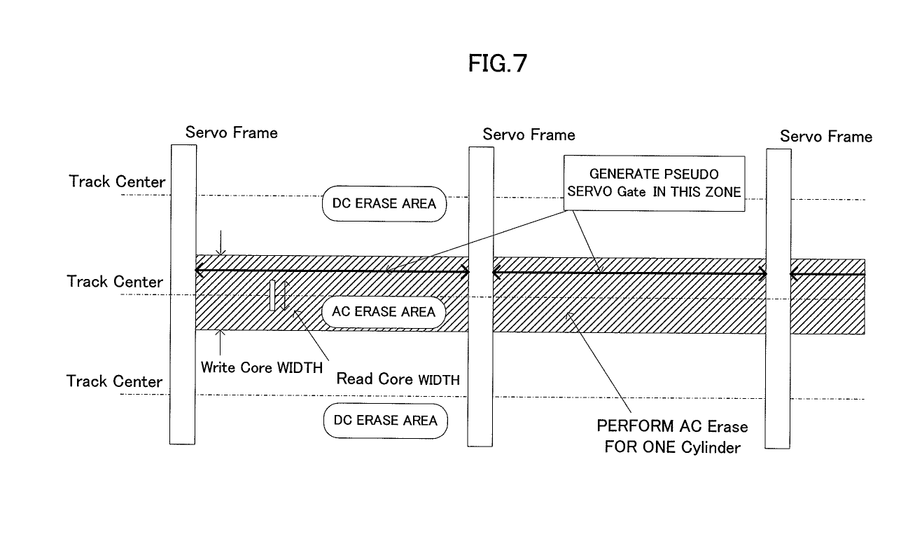

FIG. 7 is a plan view showing an example of a pattern written on the medium through the first write processing for horizontal component measurement according to the present embodiment. In FIG. 7, the vertical direction is the medium radial direction, and horizontal direction is the medium circumferential direction. Further, in FIG. 7, a shaded area corresponding to one cylinder (track) in the user data area other than the servo information (Servo Frame) is AC Erase Area and track for horizontal component measurement. The user data area other than the AC Erase Area is DC Erase Area.

First horizontal component measurement processing will next be described.

The MCU 13 positions the read core on the track for horizontal component measurement to check a variation of the ServoGain value which is output from the RDC 15. As shown in FIG. 7, the MCU 13 generates the normal servo gate when the head passes above the servo information and generates the pseudo servo gate when the head passes above the user data area. The MCU 13 may check a variation of the ServoGain value by offsetting the read core from the Track Center of the track for horizontal component measurement. In this case, the read core moves on the boundary line between the AC Erase Area and DC Erase Area in terms of the horizontal component. This increases a variation of the SevoGain value, making it easy to measure the horizontal component.

Second write processing for horizontal component measurement will next be described.

First, as in the case of the first write processing for horizontal component measurement, the MCU 13 performs AC Erase for the track for horizontal component measurement. Subsequently, the MCU 13 performs DC Erase for both sides of the Track Center of the track for horizontal component measurement while giving a predetermined offset to a write core, thereby narrowing the AC Erase Area as compared to the case of the first write processing for horizontal component measurement.

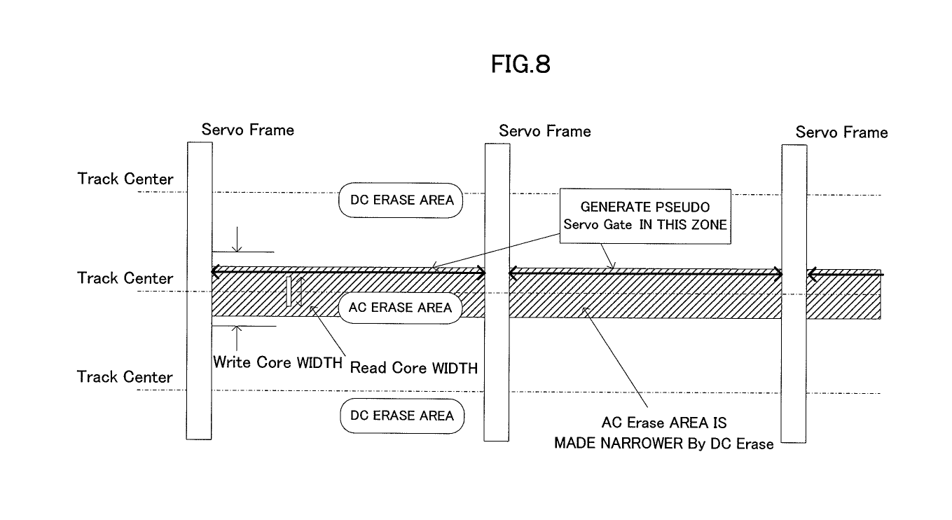

FIG. 8 is a plan view showing an example of a pattern written on a recording medium through the second write processing for horizontal component measurement according to the present embodiment. Although a pattern in FIG. 8 is located in the same position as the pattern written on the medium through the first write processing for horizontal component measurement, the width of the AC Erase Area is made narrower.

Second horizontal component measurement processing will next be described.

The MCU 13 positions the read core on the track for horizontal component measurement to check a variation of the ServoGain value which is output from the RDC 15. As shown in FIG. 8, the MCU 13 generates the normal servo gate when the head passes above the servo information and generates the pseudo servo gate when the head passes above the user data area. Since the width of the AC Erase Area is narrower than in the case of the first horizontal component measurement processing, a larger variation of the ServoGain value is observed even in the case where the horizontal component is small, thereby making it easy to measure the horizontal component. Further, the overall signal output is decreased as compared to the case of the first horizontal component measurement processing with the result that the ServoGain value is easily saturated.

The DC Erase is processing that fills the area between servo information with a DC pattern which is a waveform having a frequency of 0, as described above. However, it is likely that the amplitude of the Preamble part may vary due to a magnetic filed of the DC pattern. In this case, signal amplitude reproduced using the normal servo gates and signal amplitude reproduced using the servo gates for measurement appear different, which makes it difficult to compare the ServoGain values. In this case, the same effect as the DC Erase can be expected not by performing the DC Erase, but by writing a higher frequency signal (assuming that the Preamble part is 100 MHz, 500 MHz signal is written) than the frequency of the Preamble part. The reason for this is that writing of a high frequency signal reduces the amplitude of a reproduction signal with the result that the ServoGain value is easily saturated. An apparatus for writing a higher frequency signal than the frequency of the Preamble part may be the STW or magnetic disk drive as long as the amplitude of a reproduction signal can be reduced to saturate the ServoGain value.

The positions of the track for vertical component measurement and track for horizontal component measurement on the medium will be described.

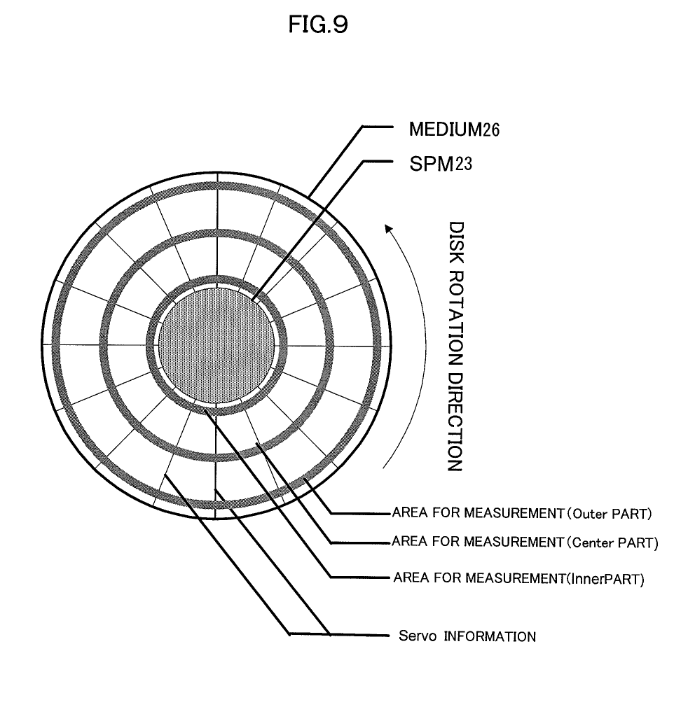

FIG. 9 is a plan view showing an example of an area for measurement on the medium according to the present embodiment. The area for measurement includes a plurality of tracks in the vicinity of the track for vertical component measurement and a plurality of tracks in the vicinity of the track for horizontal component measurement. The servo information is written radially on the medium as in a conventional approach. The areas for measurement are provided near, e.g., the outermost area (Outer part) of the medium, innermost area (Inner part) thereof, and center area (Center part) thereof. The number of locations of the area for measurement need not be three.

According to the present embodiment, by using gates for measurement having a frequency shorter than the cycle of the servo gates, it is possible to measure vibration having a frequency higher than conventional. Further, according to the present embodiment, it is possible to measure a variation in both the horizontal and vertical directions with respect to the medium surface. In a conventional approach, control by the HDC 11 is required to read out the user data area between the servo information. However, according to the present embodiment, it is only necessary to generate the pseudo servo gates, thereby enabling easy implementation. Further, only by previously measuring a correlation between the head position variation and ServoGain value variation, it is possible to calculate the head position variation from the ServoGain value variation measured according to the method of the present embodiment.

The data constituting the Position part in the servo information includes one written by an area servo method and one written by a phase servo method. Since the same AC pattern as that of the Preamble part is written in the user data area, the present embodiment can be applied to either of the above methods.

The area servo method and phase servo method will hereinafter be described. The Position part in the servo information is divided into some areas. It is assumed here that the Position part is divided into four areas: A, B, C, and D.

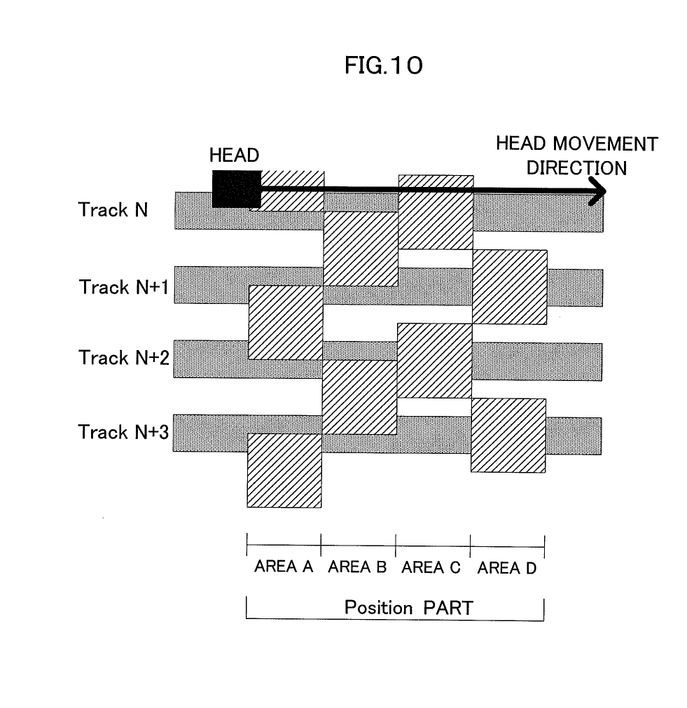

FIG. 10 is a plan view showing an example of the Position part written by the area servo method. In the area servo method, the areas A, B, C, and D are written onto different positions in the medium radial direction. The head position in the medium radial direction is detected from the amplitude of signals reproduced in respective areas. In the case where the amplitude of a signal reproduced in the area A and that of a signal reproduced in the area B are equal to each other in the example of FIG. 10, it can be determined that the head passes the Track Center. Further, it is possible to detect the offset in the medium radial direction head position from the ratio between the amplitude of a signal reproduced in the area A and that of a signal reproduced in the area B.

Although a signal is written in the entire Position part in the case of the phase servo method, the phase of the signal is changed for each area. Thus, it is possible to detect the head position in the medium radial direction from the phase of the signals reproduced in the respective areas.

A gate generation section, a measurement section, and a measurement control section correspond to the vertical component measurement processing and horizontal component measurement processing performed by the MCU 13 in the embodiment. A writing section corresponds to the writing processing for horizontal component measurement performed by the MCU 13 in the embodiment.

What is claimed is:

1. A storage apparatus capable of measuring the vibration of a head, comprising:
a gate generation section that generates a plurality of first gate signals and a second gate signal as gate signals for measurement, the first gate signals indicating the timing at which the head reads out servo information having a waveform for measurement of a reproduction signal level from a storage medium on which the servo information is written at predetermined intervals and on a first track of which a first waveform serving as a waveform for measurement of a reproduction signal level is written and which is at least a predetermined track, and the second gate signal indicating at least one timing between the first gate signals; and
a measurement section that measures the reproduction signal level of the waveform for measurement reproduced by the head at the timing of the gate signals for measurement.

2. The storage apparatus according to claim 1, further comprising a writing section that writes the waveform for measurement, wherein
after writing the first waveform, the writing section performs erase processing on a path which leads away from the center of the first track by a predetermined distance at both sides of the first track so as to narrow the width of the area of the first waveform.

3. The storage apparatus according to claim 1, wherein
the measurement section measures the reproduction signal level of the waveform for measurement with the path leading away from the center of the first track by a predetermined distance set as a path of the head.

4. The storage apparatus according to claim 1, wherein
a second waveform serving as the waveform for measurement is written in a user data area which is the area on the storage medium other than the servo information, and
the measurement section moves the head to the area of the second waveform on the storage medium, measures the vertical component of the vibration with respect to the surface of the storage medium based on the reproduction signal level of the second waveform reproduced by the head at the timing of the gate signals for measurement, moves the head to the area of the first waveform on the storage medium, and measures the horizontal component of the vibration with respect to the surface of the storage medium based on the reproduction signal level of the first waveform reproduced by the head at the timing of the gate signals for measurement.

5. The storage apparatus according to claim 4, wherein
after measuring the vertical component, the measurement section acquires the horizontal component by eliminating the vertical component from the reproduction signal level of the first waveform.

6. The storage apparatus according to claim 4, wherein
the second waveform is written on the area located within a predetermined distance from the center of a second track which is at least one predetermined track.

7. The storage apparatus according to claim 6, wherein
the predetermined distance is not less than the distance between adjacent tracks.

8. The storage apparatus according to claim 6, wherein
the second waveform is written such that phases thereof are aligned with one another in the direction perpendicular to the second track.

9. A head vibration measurement method that measures the vibration of a head in a storage apparatus, comprising:
a first waveform writing step that writes a first waveform serving as a waveform for measurement of a reproduction signal level on a first track which is at least a predetermined track, of a storage medium on which servo information having a waveform for measurement of a reproduction signal level is written at predetermined intervals; and
a measurement step that generates, as gate signals for measurement, a plurality of first gate signals indicating the timing at which the head reads out the servo information from the storage medium and a second gate signal indicating at least one timing between the first gate signals and measures the reproduction signal level of the waveform for measurement reproduced by the head at the timing of the gate signals for measurement.

10. The head vibration measurement method according to claim 9, wherein
after writing the first waveform, the first waveform writing step performs erase processing on a path which leads away from the center of the first track by a predetermined distance at both sides of the first track so as to narrow the width of the area of the first waveform.

11. The head vibration measurement method according to claim 9, wherein
the measurement step measures the reproduction signal level of the waveform for measurement with the path leading away from the center of the first track by a predetermined distance set as a path of the head.

12. The head vibration measurement method according to claim 9, further comprising, before the first waveform writing step, a second waveform writing step that writes a second waveform serving as the waveform for measurement in a user data area which is the area on the storage medium other than the servo information, wherein
the measurement step moves the head to the area of the second waveform on the storage medium, measures the vertical component of the vibration with respect to the surface of the storage medium based on the reproduction signal level of the second waveform reproduced by the head at the timing of the gate signals for measurement, moves the head to the area of the first waveform on the storage medium, and measures the horizontal component of the vibration with respect to the surface of the storage medium based on the reproduction signal level of the first waveform reproduced by the head at the timing of the gate signals for measurement.

13. The head vibration measurement method according to claim 12, wherein
after measuring the vertical component, the measurement step acquires the horizontal component by eliminating the vertical component from the reproduction signal level of the first waveform.

14. The head vibration measurement method according to claim 12, wherein
the second waveform is written on the area located within a predetermined distance from the center of a second track which is at least one predetermined track.

15. The head vibration measurement method according to claim 14, wherein
the predetermined distance is not less than the distance between adjacent tracks.

16. The head vibration measurement method according to claim 14, wherein
the second waveform is written such that phases thereof are aligned with one another in the direction perpendicular to the second track.

17. A control apparatus for a storage apparatus capable of measuring the vibration of a head, comprising:
a gate generation control section that performs control operation for generating a plurality of first gate signals and a second gate signal as gate signals for measurement,
the first gate signals indicating the timing at which the head reads out servo information having a waveform for measurement of a reproduction signal level from a storage medium on which the servo information is written at predetermined intervals and on a first track of which a first waveform serving as a waveform for measurement of a reproduction signal level is written and which is at least a predetermined track, and the second gate signal indicating at least one timing between the first gate signals; and
a measurement control section that performs control operation for measuring the reproduction signal level of the waveform for measurement reproduced by the head at the timing of the gate signals for measurement.
